(19) United States
(12) Patent Application Publication
(10) Pub. No.: US 2013/0169407 A1
(43) Pub. Date: Jul. 4, 2013

(54) WIRELESS SENSOR ACTUATOR NETWORK AND OPERATING METHOD THEREOF

(71) Applicants: Ching-Han Chen, Jinsha (TW); Jia-Hong Dai, Kaohsiung City (TW); Hsin Pei Hsieh, New Taipei City (TW); Jia-Wei Liou, Hsinchu City (TW)

(72) Inventors: Ching-Han Chen, Jinsha (TW); Jia-Hong Dai, Kaohsiung City (TW); Hsin Pei Hsieh, New Taipei City (TW); Jia-Wei Liou, Hsinchu City (TW)

(21) Appl. No.: 13/531,796

(22) Filed: Jun. 25, 2012

(30) Foreign Application Priority Data
Dec. 28, 2011 (TW) 100149104

(51) Int. Cl. G05B 11/01

(52) U.S. Cl. 340/3.1

(57) ABSTRACT

A wireless sensor actuator network (WSAN) is provided, which includes: at least one sensor, for sensing situations of surrounding environments to generate a transferring condition, the transferring condition corresponding to a transferring condition serial number; at least one actuator, driven by a driving signal; and a gateway, for receiving the transferring condition of the sensor corresponding to the transferring condition serial number, transferring an active state serial number to a transferring state serial number which meets the transferring condition according to an encoding table of the gateway, and executing functions called by the transferring state serial number to generate the driving signal for driving the actuator.

### FIELD OF THE INVENTION

The present invention relates to the field of wireless network, more particularly, to a wireless sensor actuator network and an operating method thereof.

### BACKGROUND

In recent years, a 2.4 GHz wireless transmission has been widely used, thus corresponding wireless products are also developed, and the wireless sensor network (WSN) has become an obvious popular research subject.

The WSN is a highly customized system, which needs different background knowledge according to different applications, so the developer must understand things like the control method of the sensor and the actuator, the wireless network transmission protocol, and the processor peripheral architecture, in this way, the difficulty of developing the wireless sensor network application is increased, and the prototyping time for developing each different application systems is increased, therefore, the development of the wireless sensor network application system cannot be finished in a short time.

Together with the rising of The Internet Of Things (IOT) in recent years, the quantity of codes of one WSN is often between dozens and hundreds, each code is disposed in a different place in the sensing area, if using a burning procedure of a traditional WSN, linear materials such as Joint Test Action Group (JTAG) and Universal Serial Bus (USB) must be used to perform burning on the scene, and once a program of a code needs to be updated, lots of costs of manpower and time are certainly expended.

### SUMMARY

In order to efficiently reduce the developing time and difficulty of the WSN application system prototyping time and the costs expended in remote code program updates, a wireless sensor actuator network (WSAN) and an operating method thereof are provided, which use graphic language as a basic design tool, so that the developer may develop the WSN application program via graphics, perform rapid prototyping, connect a gateway to the network, and arrange a remote code program via any device which may be connected to the network.

The present invention provides a wireless sensor actuator network, which includes:

at least one sensor, for sensing situations of surrounding environments to generate a transferring condition, the transferring condition corresponding to a transferring condition serial number;

at least one actuator, driven by a driving signal; and

a gateway, for receiving the transferring condition of the sensor corresponding to the transferring condition serial number, transferring an active state serial number to a transferring state serial number which meets the transferring condition according to an encoding table of the gateway, and executing functions called by the transferring state serial number to generate the driving signal for driving the at least one actuator.

The present invention further provides an operating method of a wireless sensor actuator network, the wireless sensor actuator network includes at least one sensor, at least one actuator and a gateway, and the operating method includes the following steps:

sensing, by the at least one sensor, situations of surrounding environments to generate a transferring condition, the transferring condition corresponding to a transferring condition serial number;

driving the at least one actuator via a driving signal;

receiving, by the gateway, the transferring condition of the sensor corresponding to the transferring condition serial number; and

transferring, by the gateway, an active state serial number to a transferring state serial number which meets the transferring condition according to an encoding table of the gateway, and executing functions called by the transferring state serial number to generate the driving signal for driving the at least one actuator.

The wireless sensor actuator network and operating method of the present invention will be described below in detail with reference to the following embodiments, and also as set forth in applicants' Taiwanese priority application No. 100149104, filed Dec. 28, 2011, the entire contents of which are hereby incorporated herein by reference. However, these embodiments are used mainly to assist in understanding the present invention, but not to restrict the scope of the present invention. Various possible modifications and alterations could be conceived of by one skilled in the art to the form and the content of any particular embodiment, without departing from the spirit and scope of the present invention, which is intended to be defined by the appended claims.

### BRIEF DESCRIPTION OF THE DRAWINGS

The present invention will become more fully understood from the detailed description given herein below for illustration only, and thus are not limitative of the present disclosure, wherein:

FIG. 1 is a schematic diagram of a WSAN of the present invention;

FIG. 2 is a block diagram of a gateway of the present invention;

FIG. 3 is a basic architectural diagram of the GRAFCET graphic descriptive language of the present invention;

FIG. 4 is a schema of graphics and languages of Divergent AND of GRAFCET graphic descriptive language of the present invention;

FIG. 5 is a schema of graphics and languages of Divergent OR of GRAFCET graphic descriptive language of the present invention;

FIG. 6 is a schema of graphics and languages of Convergent AND of GRAFCET graphic descriptive language of the present invention;

FIG. 7 is a schema of graphics and languages of Convergent OR of GRAFCET graphic descriptive language of the present invention; and

FIG. 8 is a schema describing Smart Home in GRAFCET graphic descriptive language in the present invention.

### LIST OF REFERENCE NUMERALS

20 Wireless sensor actuator network
26 Gateway
30 SRAM
32 Flash ROM
34 CPU
36 Transceiver
40 Network
42 Remote terminal machine
44 Translator
46 Editor
221, 22N Sensor
241, 24N Actuator

### DESCRIPTION OF THE PREFERRED EMBODIMENTS

In order to make the present invention more comprehensible for the skilled in the art, preferred embodiments accompanied with graphics are described in detail below to specifically explain the contents and the aims of the present invention.

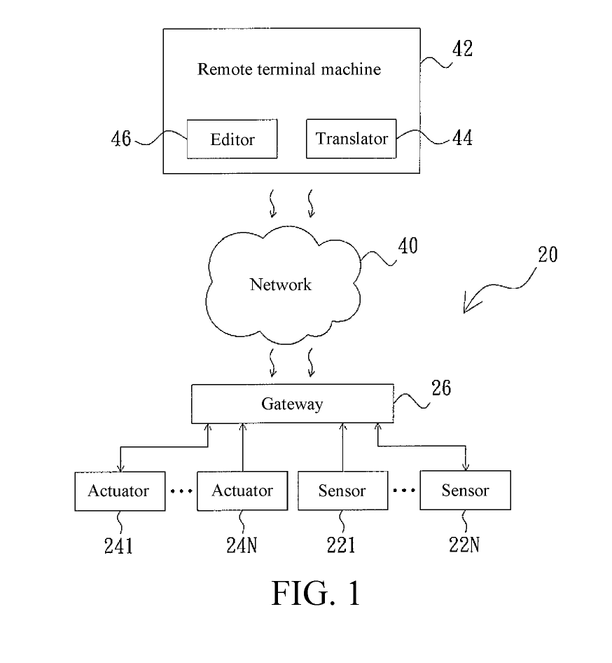

FIG. 1 is a schematic diagram of a WSAN of the present invention. In FIG. 1, the WSAN 20 includes one or more sensors 221, . . . , 22N, one or more actuators 241, . . . , 24N and a gateway 26.

The sensors 221, . . . , 22N sense situations of surrounding environments to generate a transferring condition, while the transferring condition corresponds to a transferring condition serial number. The gateway 26 receives the transferring condition of the sensors 221, . . . , 22N corresponding to the transferring condition serial number. According to an encoding table of the gateway 26, the gateway 26 transfers an active state serial number to a transferring state serial number which meets the transferring condition, and executes functions called by the transferring state serial number to generate a driving signal for driving the actuators 241, . . . , 24N.

The communication protocol of the gateway 26 and the sensors 221, . . . , 22N is Universal Asynchronous Receiver/Transmitter (UART), Serial Peripheral Interface (SPI) or Inter-Integrated Circuit (I2C). The sensors 221, . . . , 22N, for example, transmit the transferring condition to the gateway 26 in a ZigBee wireless communication way.

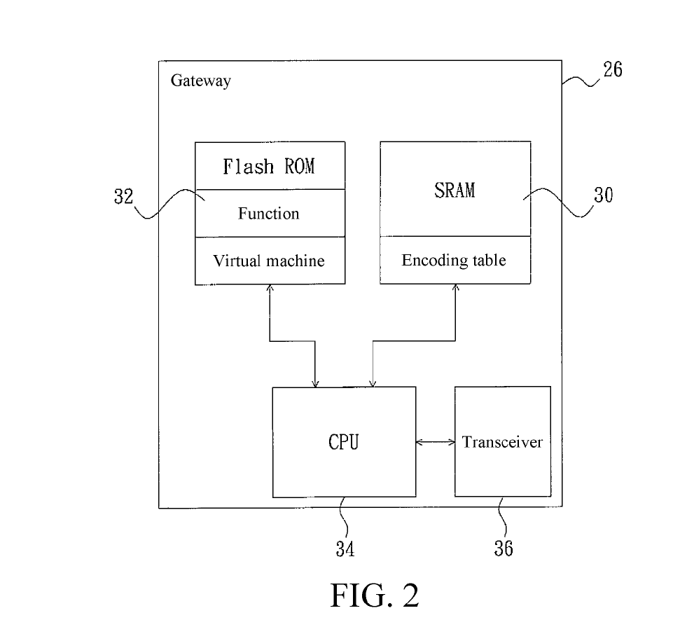

FIG. 2 is a block diagram of a gateway of the present invention. In FIG. 2, the gateway 26 may be a microprocessor, and the microprocessor includes a SRAM 30 used as a random access memory, a Flash ROM 32 used as a read only memory, a Central Processing Unit (CPU) 34 and a transceiver 36.

The SRAM 30 is used to store the encoding table. The Flash ROM 32 is used to store functions and a virtual machine (the virtual machine is used to execute the encoding table).

The CPU 34 is used to receive the transferring condition generated by the sensors 221, . . . , 22N, execute the virtual machine and the functions to generate a driving signal, transmit the driving signal to the actuators 241, . . . , 24N, and receive the encoding table transmitted by a transceiver 36 and store the encoding table in the SRAM 30. The transceiver 36 receives the encoding table from an external network 40 of the WSAN 20 in a wired or wireless manner and transmits the encoding table to the CPU 34. The network 40 is wired or wireless Internet, LAN or Cloud.

In FIG. 1, an application program of the graphic descriptive language is translated into the encoding table via a translator 44 of a remote terminal machine 42. The WSAN 20 is edited in the graphic descriptive language way by the application program via an editor 46 of the remote terminal machine 42. The remote terminal machine 42 is a computer, a tablet computer or a smart phone.

As shown in Table 1, the encoding table includes fields such as a state quantity, a transferring condition quantity, a motion quantity, a transferring condition array and a motion array of the WSAN 20. The field of the state quantity records how many states the WSAN 20 totally has, the field of the transferring condition quantity records how many transferring conditions the WSAN 20 totally has, the field of the motion quantity records how many functions of the WSAN 20 are totally called, the field of the transferring condition array records the transferring conditions in different states, and the field of the motion array records the function serial number each state is to execute.

TABLE 1

| | | | | |
|---|---|---|---|---|
| State | Transferring | Motion | Transferring | Motion |
| Quantity | Condition | Quantity | Condition | Array |
| | Quantity | | Array | |

As shown in Table 2, the transferring condition array includes fields such as the active state serial number, the transferring state serial number, the transferring condition quantity, the transferring condition descriptor index and the function serial number. The field of the active state serial number records the state serial number of the active state, the field of the transferring state serial number records the state serial number of the transferring state connected to the active state, the field of the transferring condition quantity records how many transferring conditions totally, the field of the transferring condition descriptor index records the address of the transferring condition descriptor when the quantity of the transferring condition is not 0, and the field of the function serial number records the functions called by the transferring state.

TABLE 2

| | | | | |
|---|---|---|---|---|
| Active | Transferring | Transferring | Transferring | Function |
| State Serial | State Serial | Condition | Condition | Serial |
| Number | Number | Quantity | Descriptor | Number |
| | | | Index | |

As shown in Table 3, the motion array includes fields such as the active state serial number, the function quantity, the motion descriptor index and the function serial number. The field of the active state serial number records the state serial number of the active state, the field of the function quantity records how many functions to be executed in this state, the field of the descriptor index records the address of the motion descriptor when the quantity of the transferring condition is not 0, and the field of the function serial number records the function called in this state.

TABLE 3

| | | | |
|---|---|---|---|
| Active | Function | Motion Descriptor | Function |
| State Serial | Quantity | Index | Serial |
| Number | | | Number |

The present invention uses, for example, the GRAFCET graphic descriptive language as a development tool for the application program of the WSAN 20, so that the application program of the graphic descriptive language of the WSAN 20 is edited by the editor 46 of the remote terminal machine 42, while the application program is translated into the encoding table by the translator 44 of the remote terminal machine 42, so as to efficiently simplify the software developing time and procedure of the WSAN 20.

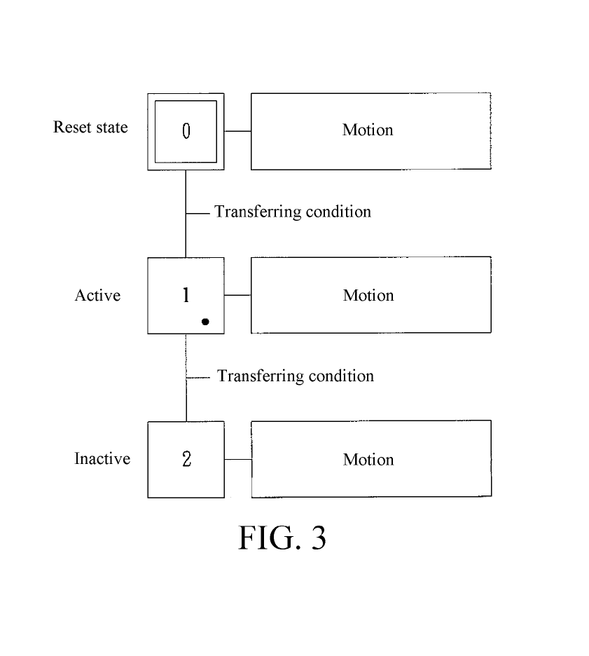

FIG. 3 is a basic architectural diagram of the GRAFCET graphic descriptive language of the present invention. The architectural diagram in FIG. 3 includes three state blocks, two transferring conditions and three motion blocks, the number in each state block represents the state serial number, and the number in each motion block represents the motion serial number.

The state block may be active or inactive, the state serial number 0 will use a double line block to represent that the state is a reset state, when the system is reset, the reset state will be active, and the motion block on the right of the state block represents the motion of this state. The black point marked on the lower right corner of the state block represents that now the state block is active, and one or more transferring conditions will be accompanied between associated states. When the gateway 26 receiving the transferring condition transmitted by the sensors 221, . . . , 22N is established, the current state of the gateway 26 is inactive, while the next state is active, and the function, stored in the Flash ROM 32 in the motion block associated by the active state, is called to generate a driving signal for driving the actuator in corresponding active state.

In FIG. 3, the grammar of the GRAFCET graphic descriptive language, describing the transferring condition between the states and the state executing procedure, is defined as follows:

“the present state serial number: the transferring condition serial number: the next state serial number”, such as:

x2: c2: x3.

The grammar, describing the function to be executed when the state is active, is defined as follows:

“the state serial number: the function name (parameter 1, parameter 2, parameter 3, parameter 4)”.

The GRAFCET graphic descriptive language has four special state transferring modes, which respectively are Divergent AND, Divergent OR, Convergent AND, and Convergent OR, and the grammar defined by the GRAFCET graphic descriptive language corresponding to the four special situations will be explained as follows.

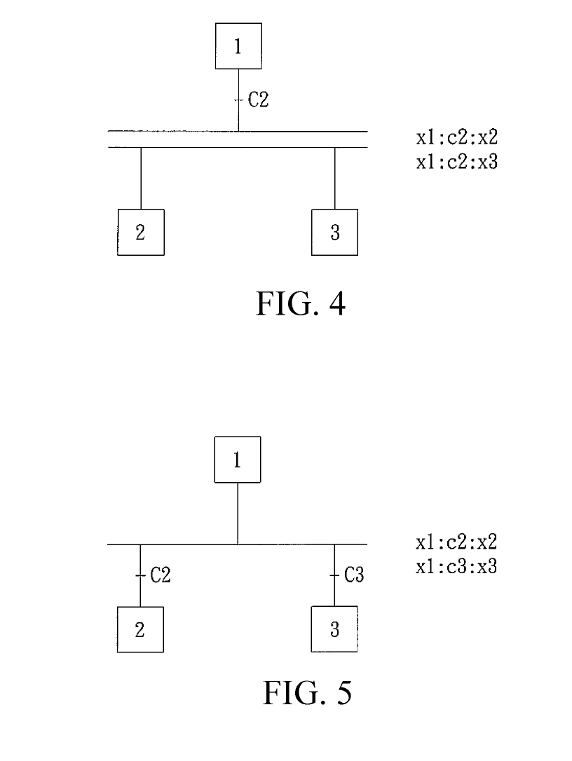

FIG. 4 is a schema of graphics and languages of Divergent AND of GRAFCET graphic descriptive language of the present invention. The graphic language of the Divergent AND in FIG. 4 is:

x1: c2: x2

x1: c2: x3.

According to the encoding table, the gateway 26 transfers the active state serial number x1 to the two transferring state serial numbers x2 and x3 which meet the transferring condition c2, and executes the functions stored in the Flash ROM 32 and called by the two transferring state serial numbers x2 and x3, so as to generate the driving signal for driving the actuator.

FIG. 5 is a schema of graphics and languages of Divergent OR of GRAFCET graphic descriptive language of the present invention. The graphic language of the Divergent OR in FIG. 5 is:

x1: c2: x2

x1: c3: x3.

The gateway 26 receives the transferring condition c2 of a first sensor 221 corresponding to a transferring condition serial number and the transferring condition c3 of a second sensor (not shown) corresponding to a second transferring condition serial number, according to the encoding table, the gateway 26 transfers the active state serial number x1 to a first transferring state serial number x2 which meets the transferring condition c2 and transfers the active state serial number x1 to a second transferring state serial number x3 which meets the transferring condition c3, and executes functions which are stored in the Flash ROM 32 and are called by the first transferring state serial number x2 and the second transferring state serial number x3 respectively, so as to generate the driving signal for driving the actuator.

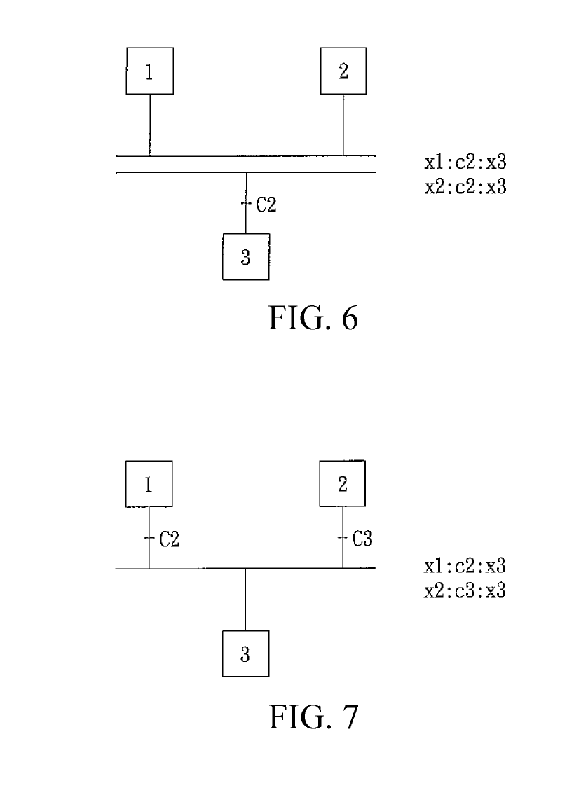

FIG. 6 is a schema of graphics and languages of Convergent AND of GRAFCET graphic descriptive language of the present invention. The graphic language of Convergent AND in FIG. 6 is:

x1: c2: x3

x2: c2: x3.

According to the encoding table, the gateway 26 transfers a first active state serial number x1 and/or a second active state serial number x2 to the transferring state serial number x3 which meets the transferring condition c2, and executes the functions which are stored in the Flash ROM 32 and are called by the transferring state serial number x3, so as to generate the driving signal for driving the actuator.

FIG. 7 is a schema of graphics and languages of Convergent OR of GRAFCET graphic descriptive language of the present invention. The graphic language of Convergent OR in FIG. 7 is:

x1: c2: x3

x2: c3: x3.

The gateway 26 receives the transferring condition c2 of a first sensor 221 corresponding to a first transferring condition serial number and the transferring condition c3 of a second sensor (not shown) corresponding to a second transferring condition serial number, according to the encoding table, the gateway 26 transfers a first active state serial number x1 to the transferring state serial number x3 which meets the transferring condition c2 and/or transfers the second active state serial number x2 to the transferring state serial number x3 which meets the transferring condition c3, and executes functions which are stored in the Flash ROM 32 and are called by the transferring state serial number x3, so as to generate the driving signal for driving the actuator.

The following embodiment applied on Smart Home is used to explain the operating method of the WSAN of the present invention.

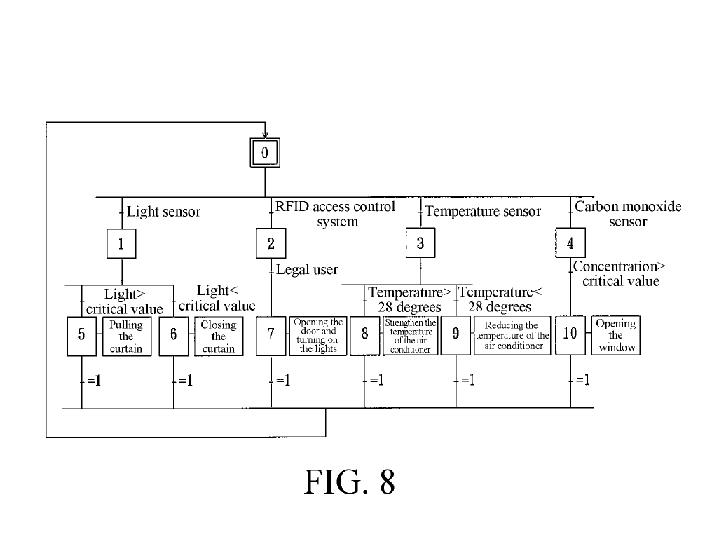

FIG. 8 is a schema describing Smart Home in GRAFCET graphic descriptive language in the present invention. A light sensor, a Radio Frequency Identification (RFID) access control system, a temperature sensor and a carbon monoxide sensor in FIG. 8 are the sensors 221, . . . , 22N as shown in FIG. 1, and a motor for pulling/closing a curtain, a switch for opening a door/turning on lights, a circuit for strengthening or reducing the temperature of an air conditioner and a device for opening a window in FIG. 8 are the actuators 241, . . . , 24N as shown in FIG. 1.

The state serial number 0 in FIG. 8 is a double line block representing that the state is the reset state, that is, when the system is reset, the reset state will be active. No motion block exists on the right of the state serial numbers 1, 2, 3, 4, which represents that the state serial numbers 1, 2, 3, 4 are in the waiting states. The function in the motion block on the right of the state serial number 5 is a function for calling to pull the curtain. The function in the motion block on the right of the state serial number 6 is a function for calling to close the curtain. The function in the motion block on the right of the state serial number 7 is a function for calling to open the door and turn on the lights. The function in the motion block on the right of the state serial number 8 is a function for calling to strengthen the temperature of the air conditioner. The function in the motion block on the right of the state serial number 9 is a function for calling to reduce the temperature of the air conditioner. The function in the motion block on the right of the state serial number 10 is a function for calling to open the window.

The “light sensor”, “RFID access control system”, “temperature sensor”, “carbon monoxide sensor”, “light>critical value critical value”, “light<critical value”, “legal user”, “temperature>28 degrees”, “temperature<28 degrees”, “concentration>critical value” and “=1” are transferring conditions, where, “=1” represents that the transferring condition is constantly true, the graphic language, for example, is x5: x0, and the description of the transferring condition being “=1” is omitted.

The graphic language, edited from the WSAN of the Smart Home in FIG. 8 by using the editor 46 of the remote terminal machine 42 in FIG. 1, is shown as follows:

x0: light sensor: x1

x0: RFID access control system: x2

x0: temperature sensor: x3

x0: carbon monoxide sensor: x4

x1: light>critical value: x5; x5: pulling the curtain (parameter 1, . . . )

x1: light<critical value: x6; x6: closing the curtain (parameter 1, . . . )

x2: legal user: x7; x7: opening the door and turning on the lights (parameter 1, . . . )

x3: temperature>28 degrees: x8; x8: strengthening the temperature of the air conditioner (parameter 1, . . . )

x3: temperature<28 degrees: x9; x9: reducing the temperature of the air conditioner (parameter 1, . . . )

x4: concentration>critical value: x10; x10: opening the window (parameter 1, . . . )

x5: x0

x6: x0

x7: x0

x8: x0

x9: x0

x10: x0.

The grammar of the previous mentioned graphic language is translated into an encoding table by using the translator 44 of the remote terminal machine 42 in FIG. 1, and the encoding table is transmitted to the gateway 26 via the network 40 by the remote terminal machine 42. The encoding table is received by the transceiver 36 of the gateway 26 and stored in the SRAM 30 in FIG. 2.

The virtual machine stored in the Flash ROM 32 is executed by the CPU 34 in FIG. 2, and the encoding table stores in the SRAM 30 and the function stored in the Flash ROM 32 are executed by the virtual machine, so as to execute the operation of the WSAN of the Smart Home.

The operating flowchart of the WSAN of the Smart Home in FIG. 8 executed by the gateway is explained according to the abovementioned graphic language of the WSAN of the Smart Home.

x0: light sensor: x1

x0: RFID access control system: x2

x0: temperature sensor: x3

x0: carbon monoxide sensor: x4

Since x0 is the reset state, the gateway resets the WSAN, and activates the light sensor, the RFID access control system, the temperature sensor and the carbon monoxide sensor. Since the transferring conditions of “light sensor”, “RFID access control system”, “temperature sensor” and “carbon monoxide sensor” are active, the gateway transfers the state serial number 0 to the state serial number 1, the state serial number 2, the state serial number 3 and the state serial number 4 respectively according to the encoding table. No motion block exists on the right of state serial number 1, the state serial number 2, the state serial number 3 or the state serial number 4 (that is, no function is called), thus the state serial number 1, the state serial number 2, the state serial number 3 and the state serial number 4 are in the waiting states.

x1: light>critical value: x5; x5: pulling the curtain (parameter 1, . . . )

The light sensor senses the luminance of the light is larger than the critical value set by the light sensor, the light sensor transmits the transferring condition of “light>critical value” to the gateway, the CPU of the gateway transfers the state serial number 1 to the state serial number 5 which meets the transferring condition according to the encoding table, and the CPU calls the function of “pulling the curtain” of the state serial number 5 to generate the driving signal, and transmits the driving signal to the motor for pulling/closing the curtain, so as to drive the motor to pull the curtain.

x1: light<critical value: x6; x6: closing the curtain (parameter 1, . . . )

The light sensor senses the luminance of the light is smaller than the critical value set by the light sensor, the light sensor transmits the transferring condition of “light<critical value” to the gateway, the CPU of the gateway transfers the state serial number 1 to the state serial number 6 which meets the transferring condition according to the encoding table, and the CPU calls the function of “closing the curtain” of the state serial number 6 to generate the driving signal, and transmits the driving signal to the motor pulling/closing the curtain, so as to drive the motor to close the curtain.

x2: legal user: x7; x7: opening the door and turning on the lights (parameter 1, . . . )

The RFID access control system identifies the identity of the user, the RFID access control system transmits the transferring condition of “legal user” to the gateway, the CPU of the gateway transfers the state serial number 2 to the state serial number 7 which meets the transferring condition according to the encoding table, and the CPU calls the function of “opening the door and turning on the lights” of the state serial number 7 to generate the driving signal, and transmits the driving signal to the switch opening the door/turning on the lights, so as to drive the switch to open the door and turn on the lights.

x3: temperature>28 degrees: x8; x8: strengthening the temperature of the air conditioner (parameter 1, . . . )

The temperature sensor senses the surrounding temperature is higher than 28 degrees, the temperature sensor transmits the transferring condition of “temperature>28 degrees” to the gateway, the CPU of the gateway transfers the state serial number 3 to the state serial number 8 which meets the transferring condition according to the encoding table, and the CPU calls the function of “strengthening the temperature of the air conditioner” of the state serial number 8 to generate the driving signal, and transmits the driving signal to the circuit strengthening/reducing the temperature of the air conditioner, so as to strengthen the temperature of the air conditioner.

x3: temperature<28 degrees: x9; x9: reducing the temperature of the air conditioner (parameter 1, . . . )

The temperature sensor senses the surrounding temperature is lower than 28 degrees, the temperature sensor transmits the transferring condition of “temperature<28 degrees” to the gateway, the CPU of the gateway transfers the state serial number 3 to the state serial number 9 which meets the transferring condition according to the encoding table, and the CPU calls the function of “reducing the temperature of the air conditioner” of the state serial number 9 to generate the driving signal, and transmits the driving signal to the circuit strengthening/reducing the temperature of the air conditioner, so as to reduce the temperature of the air conditioner

x4: concentration>critical value: x10; x10, opening the window (parameter 1, . . . )

The carbon monoxide sensor senses the carbon monoxide concentration in the surrounding environment is larger than the critical value set by the carbon monoxide sensor, the carbon monoxide sensor transmits the transferring condition of “concentration>critical value” to the gateway, the CPU of the gateway transfers the state serial number 4 to the state serial number 10 which meets the transferring condition according to the encoding table, and the CPU calls the function of “opening the window” of the state serial number 10 to generate the driving signal, and transmits the driving signal to the device opening the window, so as to drive the device to open the window.

x5: x0

x6: x0

x7: x0

x8: x0

x9: x0

x10: x0

After the gateway executes the function called by the state serial number 5, the gateway transfers the state serial number 5 to the state serial number 0 according to the encoding table, similarly, after the gateway executes the function called by the state serial number 6, 7, 8, 9 or 10, the gateway transfers the state serial number 6, 7, 8, 9 or 10 to the state serial number 0 according to the encoding table. The state serial number 0 is the reset state, so the gateway resets the WSAN again.

The advantage of the present invention is to provide an operating method of a WSAN, which efficiently reduces the developing time and difficulty of the WSN application system prototyping time, and the costs used in remote code program updates, and which uses the graphic language as a basic design tool, so the developer may develop a WSN application program via graphics, perform rapid prototyping, connect the gateway to the network, and arrange a remote code program via any device which may be connected to the network.

Although the present invention is disclosed with reference to embodiments above, the embodiments are not intended to limit the present invention. Various variations and modifications can be made by persons skilled in the art without departing from the spirit and the scope of the present invention, so the protection scope of the present invention should be subject to what is defined in appended claims.

What is claimed is:

1. A wireless sensor actuator network (WSAN), comprising:
at least one sensor, for sensing situations of surrounding environments to generate a transferring condition, the transferring condition corresponding to a transferring condition serial number;
at least one actuator, driven by a driving signal; and
a gateway, for receiving the transferring condition of the sensor corresponding to the transferring condition serial number, transferring an active state serial number to a transferring state serial number which meets the transferring condition according to an encoding table of the gateway, and executing functions called by the transferring state serial number to generate the driving signal for driving the at least one actuator.

2. The WSAN according to claim 1, wherein,
the encoding table comprises a state quantity, a transferring condition quantity, a motion quantity, a transferring condition array and a motion array of the WSAN.

3. The WSAN according to claim 2, wherein,
the transferring condition array comprises the active state serial number, the transferring state serial number, the transferring condition quantity, a transferring condition descriptor index and a function serial number.

4. The WSAN according to claim 2, wherein,
the motion array comprises the active state serial number, a function quantity, a motion descriptor index and a function serial number.

5. The WSAN according to claim 1, wherein,
the gateway transfers the active state serial number to two transferring state serial numbers which meet the transferring condition according to the encoding table, and executes functions called by the two transferring state serial numbers to generate the driving signal for driving the at least one actuator.

6. The WSAN according to claim 1, wherein,
the gateway receives the transferring condition of a first sensor corresponding to a first transferring condition serial number and the transferring condition of a second sensor corresponding to a second transferring condition serial number, according to the encoding table, the gateway transfers the active state serial number to a first transferring state serial number which meets the transferring condition of the first transferring condition serial number and transfers the active state serial number to a second transferring state serial number which meets the transferring condition of the second transferring condition serial number, and executes functions called by the first transferring state serial number and the second transferring state serial number respectively to generate the driving signal for driving the at least one actuator.

7. The WSAN according to claim 1, wherein,
the gateway transfers a first active state serial number and/or a second active state serial number to the transferring state serial number which meets the transferring condition according to the encoding table, and executes functions called by the transferring state serial number to generate the driving signal for driving the at least one actuator.

8. The WSAN according to claim 1, wherein,
the gateway receives the transferring condition of a first sensor corresponding to a first transferring condition serial number and the transferring condition of a second sensor corresponding to a second transferring condition serial number, according to the encoding table, the gateway transfers a first active state serial number to the transferring state serial number which meets the transferring condition of the first transferring condition serial number and/or transfers the second active state serial number to the transferring state serial number which meets the transferring condition of the second transferring condition serial number, and executes functions called by the transferring state serial number to generate the driving signal for driving the at least one actuator.

9. The WSAN according to claim 1, wherein,
the gateway is a microprocessor, and the microprocessor comprises:
a random access memory (RAM), for storing the encoding table;
a read only memory (ROM), for storing functions and a virtual machine for executing the encoding table;
a central processing unit (CPU), for receiving the transferring condition, executing functions and the virtual machine to generate the driving signal, transmitting the driving signal to the at least one actuator, and receiving the encoding table and storing the encoding table in the RAM; and
a transceiver, receiving the encoding table and transmitting the encoding table to the CPU.

10. The WSAN according to claim 1, wherein, the communication protocol of the gateway and the at least one sensor is one of Universal Asynchronous Receiver/Transmitter (UART), Serial Peripheral Interface (SPI) and Inter-Integrated Circuit (I2C).

11. The WSAN according to claim 1, wherein,
the at least one sensor transmits the transferring condition to the gateway in a ZigBee wireless communication way.

12. The WSAN according to claim 1, wherein,
the gateway receives the encoding table via a network.

13. The WSAN according to claim 12, wherein,
the network is one of Internet, Local Area Network and Cloud.

14. The WSAN according to claim 1, wherein,
the encoding table is translated from an application program of graphic descriptive language via a translator of a remote terminal machine.

15. The WSAN according to claim 14, wherein,
the application program is edited from the WSAN via an editor of the remote terminal machine.

16. The WSAN according to claim 14, wherein,
the remote terminal machine is one of a computer, a tablet computer and a smart phone.

17. An operating method of a wireless sensor actuator network (WSAN), wherein the WSAN comprises at least one sensor, at least one actuator and a gateway, the operating method comprising:
sensing, by the at least one sensor, situations of surrounding environments to generate a transferring condition, the transferring condition corresponding to a transferring condition serial number;
driving the at least one actuator via a driving signal;
receiving, by the gateway, the transferring condition of the sensor corresponding to the transferring condition serial number; and
transferring, by the gateway, an active state serial number to a transferring state serial number which meets the transferring condition according to an encoding table of the gateway, and executing functions called by the transferring state serial number to generate the driving signal for driving the at least one actuator.

18. The operating method according to claim 17, wherein, the encoding table comprises a state quantity, a transferring condition quantity, a motion quantity, a transferring condition array and a motion array of the WSAN.

19. The operating method according to claim 18, wherein, the transferring condition array comprises the active state serial number, the transferring state serial number, the transferring condition quantity, a transferring condition descriptor index and a function serial number.

20. The operating method according to claim 18, wherein, the motion array comprises the active state serial number, a function quantity, a motion descriptor index and a function serial number.

21. The operating method according to claim 17, wherein, the gateway transfers the active state serial number to two transferring state serial numbers which meet the transferring condition according to the encoding table, and executes functions called by the two transferring state serial numbers to generate the driving signal for driving the at least one actuator.

22. The operating method according to claim 17, wherein,
the gateway receives the transferring condition of a first sensor corresponding to a first transferring condition serial number and the transferring condition of a second sensor corresponding to a second transferring condition serial number; and
the gateway transfers the active state serial number to a first transferring state serial number which meets the transferring condition of the first transferring condition serial number and transfers the active state serial number to a second transferring state serial number which meets the transferring condition of the second transferring condition serial number according to the encoding table, and executes functions called by the first transferring state serial number and the second transferring state serial number respectively to generate the driving signal for driving the at least one actuator.

23. The operating method according to claim 17, wherein, the gateway transfers a first active state serial number and/or a second active state serial number to the transferring state serial number which meets the transferring condition according to the encoding table, and executes functions called by the transferring state serial number to generate the driving signal for driving the at least one actuator.

24. The operating method according to claim 17, wherein,
the gateway receives the transferring condition of a first sensor corresponding to a first transferring condition serial number and the transferring condition of a second sensor corresponding to a second transferring condition serial number; and
the gateway transfers a first active state serial number to the transferring state serial number which meets the transferring condition of the first transferring condition serial number and/or transfers the second active state serial number to the transferring state serial number which meets the transferring condition of the second transferring condition serial number according to the encoding table, and executes functions called by the transferring state serial number to generate the driving signal for driving the at least one actuator.

25. The operating method according to claim 17, wherein,
the gateway is a microprocessor, the microprocessor comprises a random access memory (RAM), a read only memory (ROM), a central processing unit (CPU) and a transceiver, and the operating method comprises:
storing, by the RAM, the encoding table;
storing, by the ROM, functions and a virtual machine for executing the encoding table;
receiving, by the CPU, the transferring condition, executing functions and the virtual machine to generate the driving signal, transmitting the driving signal to the at least one actuator, and receiving the encoding table and storing the encoding table in the RAM; and
receiving, by the transceiver, the encoding table and transmitting the encoding table to the CPU.

26. The operating method according to claim 17, wherein, the at least one sensor transmits the transferring condition to the gateway in a ZigBee wireless communication way.

27. The operating method according to claim 17, wherein, the gateway receives the encoding table via the network.

28. The operating method according to claim 17, wherein, the encoding table is translated from an application program of graphic descriptive language via a translator of a remote terminal machine.

29. The operating method according to claim 28, wherein, the WSAN is edited into the application program via an editor of the remote terminal machine.
